(19) United States
(12) Patent Application Publication
(10) Pub. No.: US 2010/0151225 A1
(43) Pub. Date: Jun. 17, 2010

(54) Thermal barrier mineral foam polyurethane and so forth

(76) Inventor: Michael John Mabey, Sherwood Park (CA)

Correspondence Address: CHRISTOPHER JOHN RUDY, 209 HURON AVENUE, SUITE 8, PORT HURON, MI, 48060, US

(21) Appl. No.: 12/317,715

(22) Filed: Dec. 23, 2008

Related U.S. Application Data
(60) Provisional application No. 61/009,488, filed on Dec. 28, 2007.

(51) Int. Cl. C08L 75/00; C08K 3/22; C08K 3/12; C08K 3/30; B32B 3/26; B01J 19/00

(52) U.S. Cl. 428/304.4; 524/589; 524/590; 524/401; 524/423; 521/155; 422/133

(57) ABSTRACT

Thermal barrier synthetic polymer composite embraces a synthetic polymer matrix made from reaction of a mixture of at least an isocyanate and an active hydrogen-containing compound, in intimate admixture and combination with at least one water-releasing mineral additive. Thermal barrier, fire resistance, fire retardant, and smoke reducing properties are provided by the composite.

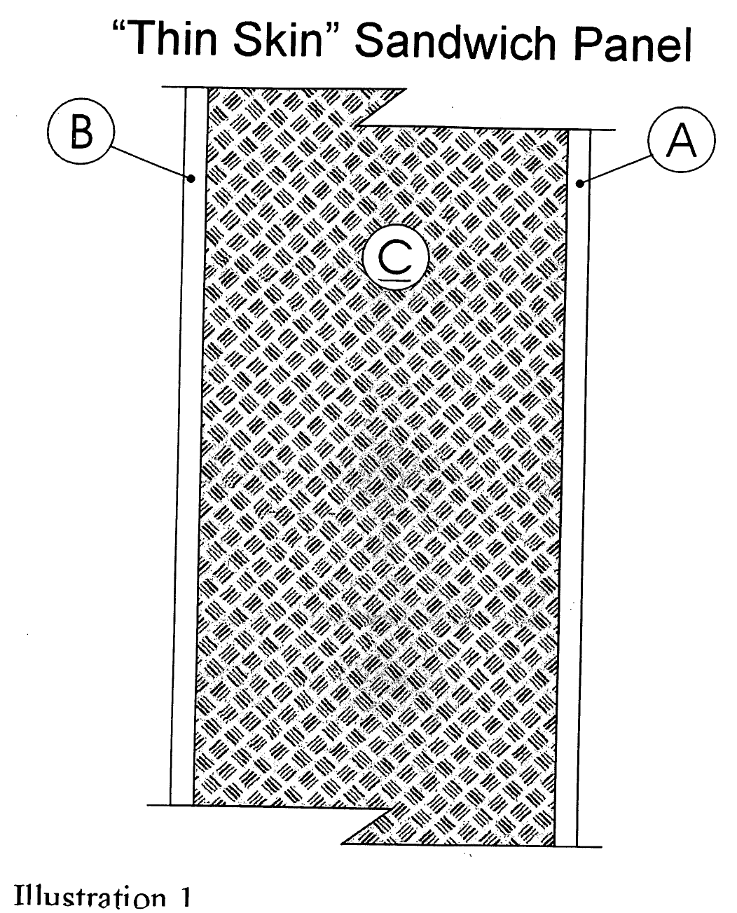

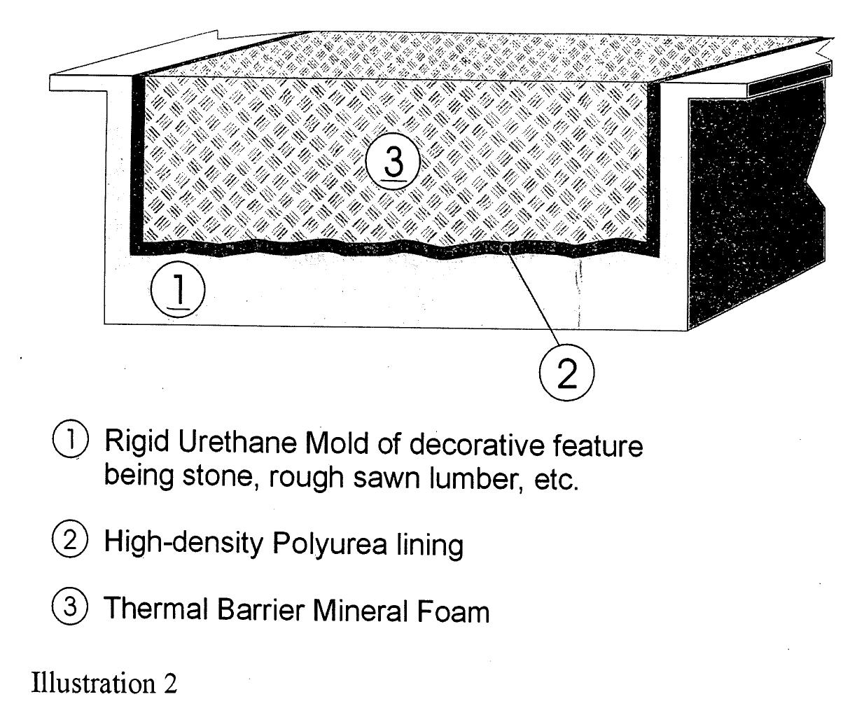

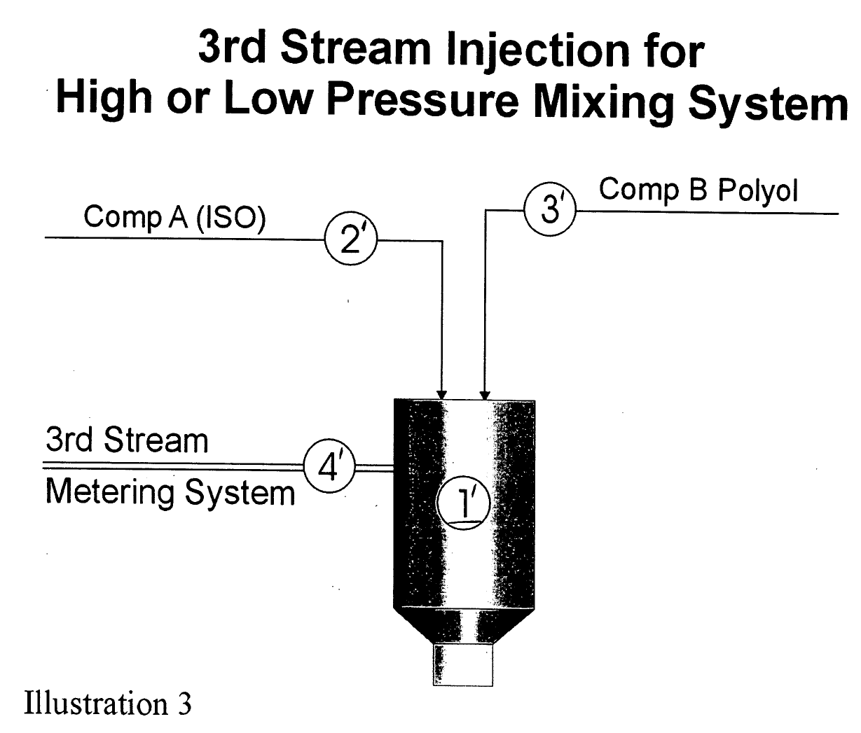

This claims priority benefits of provisional patent application No. U.S. 61/009,488 filed on Dec. 28, 2007 A.D. In the U.S.A., this is done under 35 U.S.C. 119(e). With respect to the U.S.A. especially, the entire specification of that application is incorporated herein by reference.

### FIELD AND PURVIEW OF THE INVENTION

This concerns a composite embracing a matrix with a polymer intrinsically including a suitable mineral additive for enhanced thermal barrier, fire retardant, and smoke reducing properties. The polymer may be considered to be filled with the mineral additives.

The polymer generally is formed with an isocyanate and an organic active hydrogen compound such as a polyol, polythiol, polyamine, polyimine or isocyanate itself, say, the polyol, and thus be a polymer such as a polyurethane, polyurethaneurea, polyurea, polyisocyanurate, or analog thereof, including halogenated compositions, and may be foamed. For instance, it may be the polyurethane, especially a rigid polyurethane foam

The mineral additive generally can include a particulate water-releasing compound or mixture of compounds, say, such as with a basic, hydrated filler, which can provide for release of water at different, predetermined, elevated temperatures, say, a temperature below about 200° C. and a temperature at or above about 200° C., for example, a mixture of calcium sulfate dihydrate (CSD) and aluminum trihydrate (ATH), which can begin to evolve water at about 140° C. from CSD and about 240° C. from ATH. Another water-releasing compound, which may be a hydrate, hydroxide, and so forth and the like, say, of a suitable metal, may be employed as well, an example being magnesium hydroxide (Mg(OH)₂), which will contribute water at a more elevated temperature about from 400° C. to 450° C. to further increase thermal resistance and reduce levels of smoke otherwise developed during sustained combustion. Such water-releasing mineral additives play a vital role in adding what is termed, “fire resistance,” to the composite, compared to what is termed, “fire retardancy,” which otherwise basically characterizes the composite.

Generally, the mineral additives are made an intrinsic inclusion by carefully blending them during formation of the polymer, say, by being introduced in one or both of a first stream of the isocyanate and a second stream of the organic active hydrogen compound, which are blended to react to make the composite with the polymer matrix having the mineral additives, or introduced as a 3rd stream during blending of first and second streams of the isocyanate and organic active hydrogen compound. Such may be assisted by employment of a reactive diluent such as a suitable organic phosphorus compound, for example, (tris(2-chloroethyl)) phosphate, or selected from a variety of other low viscosity liquid phosphates or phosphonates, in combination with dispersing agent(s), defoaming agent(s), smoke suppressant(s) and/or anti-settling agent(s) and so forth. Improved functionality can be provided by incorporation of such very low viscosity reactive diluents with flame reduction properties also as a carrier to facilitate homogeneous dispersion of fines such as the mineral additives into the composite matrix.

### BACKGROUND TO THE INVENTION

Because of the natural flammability of organic polymer resins, it is common practice to incorporate a flame retardant into the formulation of a resin based composition or system in order to improve the fire safety of the final product. A common approach is to incorporate into the resin certain flame inhibiting compounds such as a phosphate, which may be in powder form, for example, monammonium phosphate, diammoniun phosphate, ammonium polyphosphate, or a liquid form. Other approaches employ melamine, other amines, bromides, chlorides and/or oxides. Generally when compounded into resins at sufficient levels, these compounds impart flame retardant capability by interrupting the chemistry of combustion, evolving non-combustible gases and/or promoting char formation to limit flame spread along the exposed surface of the substrate when tested with the Steiner Tunnel Test (ASTM-E84 in the U.S.A. or Can4/ULC-S 102 in Canada). While proven effective in many non-foamed plastics, fire resistance, high-temperature thermal resistance or thermal barrier properties may be problematic or unknown concerning such in foamed plastics.

Also, in particular, high levels of powdered phosphates can affect the physical properties of the final product, for example, engendering friability in foamed polyurethane. An excessive amount liquid phosphate can retard polymerization or lead to extended reaction times, and soft or inconsistent compressive strength, for example, in a polyurethane matrix.

In addition, high loadings of metal hydrate fines can lead to steam and fissures caused when a portion of the available water, or surface moisture on the particles themselves, reacts with isocyanate during polymerization, which leads to poor quality castings and parts. Compare, U.S. Pat. No. 5,053,274 to Jonas, which discloses highly filled, substantially solid polyurethane, urea and isocyanurate composites for indoor and outdoor applications, for load bearing, structural and decorative products.

Nonetheless, certain special problems exist, especially when levels of visible and/or toxic smoke are taken into consideration. Many North American building codes specify limits on the amount of visible smoke that would permitted during combustion, and these limits can effectively prohibit the use of many non-foamed and foamed plastics for interior finishes.

In addition, products falling under the meaning of the term, “foamed plastics,” as defined in most building and fire codes, are required to be protected by being covered with approved materials, termed, “thermal barriers,” usually a sheet of gypsum board (drywall), in order to meet the requirements of the code. A pertinent index is defined as the time, in minutes, at which the surface of the substrate being protected from fire reaches either an average temperature rise of 250° F. or a single maximum rise of 325° F. as an assembly is subjected to a specified fire exposure such as the ASTM E-119 or corresponding Can4/ULC-S124 time-temperature curve. Such temperature-rise criteria are also referred to as the finish rating or the protective membrane performance. See, e.g., Forest Products Journal, Vol. 32, No. 7, “Thermal barrier Fire Testing . . . revision to the ICBO Building Code,” 1982.

As alluded to above, among the countless known plastic and composite formulations, a number include in varying amounts compounds that can release water when heated to a point where combustion would be sustained. It is known thus to employ dihydrate to decahydrate compounds for such a purpose in plastics, including extruded plastics, electrical cable jackets, films, and non-foamed solids. It is often said that such these additives reduce flame spread and combustion byproducts—primarily because they lower the flame spread ratings and smoke index when tested by the Steiner Tunnel Test, which measures the distance that a flame travels along an exposed surface of the product in ten minutes so as to obtain a flame spread rating, and measures the opacity of smoke developed over the duration of the test with a photoelectric cell so as to obtain a smoke developed rating. These tests may validate the efficacy of hydrate fines in plastic films and cable jackets.

However that may be, the inclusion of such hydrates into many of such plastic formulations has been shown to rob those plastics of critical performance properties. Such properties can include flexibility, workability, weatherability, and flexural and tensile strength.

Although there is considerable advantage to reducing flame spread and smoke developed ratings for products tested under ASTM-E84 and Can4/ULC-S 102, the use of such products is still subject to considerable constraint in the construction market. For example, polyurethane products, and “foamed plastics” in particular, can exhibit typical flame spread ratings of 150-450 and smoke developed ratings of 450-600 plus. This limits the use of such polyurethane products for interior installations under most building codes in both countries owing to such rapid flame progression and excessively high smoke levels.

Furthermore, while some formulations can provide flame spread and smoke developed ratings that can achieve a Class A flame spread rating, most are based on very lightweight or low density products, typically 2 to 3 lb./cu. ft. These simply burn away during the Steiner Tunnel Test or UL-723 equivalent, and simply do not supply sufficient fuel to carry the fire down the tunnel, thus gaining a low flame spread and smoke developed rating due in large part to the very low density and consequent minimal fuel able to be contributed.

However, when these products are classified as “foamed plastic,” they are subject to additional rules requiring that they be covered by a material known as a “thermal barrier,” which is a covering that must meet the requirements of the ASTM-E119 or corresponding Can4/ULC-S124 test protocol. This thermal barrier test protocol requires that the covering be exposed to elevated temperatures in excess of 1200° F. and be of sufficient thermal resistance to protect the foamed plastic from temperatures in excess of 140° C. to 180° C. (250° F. to 325° F.) for a period of ten to fifteen minutes. Protection of this magnitude is commonly provided simply by the application of a single sheet of ½-inch drywall covering the exposed face of the foamed plastic substrate. In some jurisdictions, testing such as that of UL-1715 applies.

While many times the installation of a sheet of drywall is not an undue hardship, there are situations where the installation of the drywall cover may completely negate the advantage of installing the foamed plastic substrate. One manifest disadvantage of installing drywall as a thermal barrier board would be in situations where the foamed plastic had been installed for its decorative features such as the case wherein a foamed urethane plastic formed a decorative, ornamental feature such as the manufacture of decorative stone-like veneers, imitation rough sawn timbers, and the like. Generally, if this decorative material or a foamed plastic in general is installed such that it covers more than about 10% o the surface area of a wall or ceiling, say, in a building for occupancy, unless it itself is classified as a thermal barrier, drywall or another acceptable thermal barrier must cover it in order to meet the building codes particularly in much of North America. Another disadvantage would be found in an outdoor application where gypsum-based drywall would degrade rapidly. In other situations, the foamed plastic may function as an insulator or pipe covering, which, too, would require significant labor and materials to cover with drywall, if indeed it were practical at all.

Returning to the hydrated compounds known to be employed as mentioned above, among such compounds include flame inhibiting hydrated minerals such as ATH, and others. When these hydrated minerals are incorporated as powders into resins at sufficient levels, they impart some degree of both flame and smoke retardant capability when at elevated temperatures they evolve non-toxic gases such as water vapor to dilute the combustion products and promote char formation. Although these hydrated minerals have met with some success as flame-retardants, certain problems exist. For example, with respect to polyurethanes, high loadings of ATH or the other hydrates can affect the viscosity of liquid polyol side of the formulation where they are typically employed and make blending and casting of urethane shapes difficult due to the extremely high viscosities of the liquid-powder blends. Also, as mentioned previously in general, friability of polyurethane foams can be a problem with the high loadings of ATH required to impart the desired flame and smoke retardant capability to the foam. Another challenge imposed by incorporation of these hydrated fines is that the equipment commonly used to pump, meter and blend these viscous liquids are not usually designed to handle fines and fillers. Existing pumps and filters designed to carry and move clear fluids will not generally allow filled materials to pass without significant and expensive modifications, and fillers incorporated into either the isocyanate containing component (A-side) or the polyol containing component (B-side) will also significantly limit or shorten the pot life of these products, due to the inevitable introduction of even very small amounts of moisture, which will react with the isocyanate in storage, or the differences in density will cause separation, settling and inconsistent results when pre-mixed in the B-side. But see, the Jona U.S. Pat. No. 5,503,274.

In fine, while polyurethane is ideally suited to creating lightweight decorative materials, which can be employed in periodically done hotel and motel renovations and so forth, it would be used there and classified as a foamed plastic and subject to the need to be covered or protected by a sheet of drywall or some other approved thermal barrier cover. And there is a need to find a way of overcoming the building code restrictions on foamed plastic.

Various additional U.S. patent art may be further illustrative:

U.S. Pat. No. 4,547,526 to Al-Tabaqchali et al. This discloses a flame protecting composition comprising aluminum trihydrate, organic binder, and a sulfur compound and a polyurethane foam provided with such flame-protection composition.

U.S. Pat. No. 4,876,291 to Dallavia, Jr., et al. This discloses a mineral filler fire retardant composition and method.

U.S. Pat. No. 5,444,115 to Hu et al. This discloses a fire resistant poly(methylmethacrylate) composition.

U.S. Pat. No. 5,508, 315 to Mushovic. This discloses cured unsaturated polyester-polyurethane hybrid highly filled resins.

U.S. Pat. No. 5,741,825 to Inagaki et al. This discloses a thermal insulating foamed material and method for manufacturing the same.

U.S. Pat. No. 6,284,812 to Rotermund et al. This discloses thermally stable rigid foams based on isocyanate and having low brittleness and low thermal conductivity.

U.S. Pat. No. 6,302,916 to Townley et al. This discloses polyurethane and so forth containing joints.

U.S. Pat. No. 6,605,650 to Roth. This discloses a process of making lightweight, rigid polyurethane foam.

U.S. Pat. No. 6,790,906 to Chaignon et al. This discloses fire-retardant polyurethane systems.

Pub. No. 2006/0089444 of Goodman et al. This discloses flame retardant polymer compositions comprising a particulate clay mineral.

It would be desirable to ameliorate or overcome problem(s) in the art. It would be desirable to provide alternative(s) to the art.

It would be desirable, moreover, to provide a thermal barrier rating along with fire retardant properties, plus smoke reduction, with respect to a synthetic polymer, especially a foam, for instance, a foamed polyurethane. It would be desirable to provide a filled polyurethane foam that has good properties, especially as a rigid foam. It would be especially desirable to provide a rigid polyurethane type material having sufficient fire resistance to meet with thermal barrier approval under many if not most or even all North American building codes when tested with regard to the ASTM E-119 fifteen-minute rating, and also having an ASTM E-84 Class 1 flame spread rating with a smoke developed rating of 450 or less.

It would be desirable, furthermore, to provide an additive and delivery system that may allow employment of standard polyurethane blending equipment with respect to mixing of an A-side with a B-side for a polyurethane, without a need to make significant modifications to such equipment. It would be additionally desirable if such an additive were storage stable and able to be introduced with A-side and B-side mixing, and even more desirable if such an additive or system were convenient and economical.

### A FULL DISCLOSURE OF THE INVENTION

In general, as alluded to in the purview of the invention above, provided is a synthetic polymer blend, which can be cured into solid composite, intrinsically including a suitable mineral additive, optionally with one or more substances, which may include a liquid flame retardant, a smoke suppressant, a defoamer, a dispersant and/or an anti-settling agent, for thermal barrier, fire resistance, fire retardant and smoke reducing properties, notably in the composite. The composite can be considered to be a polymer filled with one or more the mineral additives. The polymeric composite can be formed with an isocyanate plus an organic active hydrogen compound such as a polyol, polythiol, polyamine, polyimine, or even isocyanate itself, and so forth, for instance, the polyol, and thus have a matrix of a polymer such as a polyurethane, polyurethaneurea, polyurea, polyisocyanurate, or analog thereof, including, where applicable, a halogenated polymer. The polymeric composite may be a non-foamed solid or be a foamed substance of lighter weight. It may be, for instance, the polyurethane, especially a foam, especially a rigid foam, especially having a density, say, about from 10 to 20 or 25 lb./cu. ft. The mineral additive can be a particulate water-releasing compound or mixture of compounds, say, a basic, hydrated and/or hydroxide particulate material, especially of a suitable metal, for instance, being a mixture of different mineral additives, which can provide for release of water at different, generally predetermined, successively higher elevated temperatures to provide for and extend fire resistance of the polymeric composite at ever higher temperatures under sustained combustion. The mineral additive is made an intrinsic inclusion by providing it during polymer formation, which may be assisted by a reactive diluent, say, by blending it with the reactive diluent as well as, for instance, one or more of the liquid flame retardants, smoke suppressant, defoamer, dispersant and/or anti-settling agent, which may be provided in a separate liquid slurry delivered as a separate stream, say, as A- and B-sides are provided, at the point of liquid mixture.

The invention is useful as a thermal barrier, fire resisting, fire retarding and/or smoke retarding synthetic plastic. It may be employed as a building material in building construction.

Significantly, by the invention, the art is advanced in kind. Not only is a plastic product that can serve as a thermal barrier and fire retardant provided, but also the plastic product can have smoke retardant capability as well as improved, extended fire resistance. This all can extend over a generous range of temperatures. For example, a foamed polyurethane may be filled with mineral additives that release water at a temperature below about 200° C. and a temperature at or above about 200° C., say, with a mixture of CSD and ATH, which can begin to evolve water at temperatures about 140° C. and 240° C., respectively, to afford such capabilities. In addition, further water-releasing mineral additives may be employed to boost the capability. For example, Mg(OH)₂, which will contribute water at greatly elevated temperatures about from 400° C. to 450° C., may be employed as a component of the composition so as to further increase thermal barrier capability as through increased, extended fire resistance, and also to further reduce levels of smoke otherwise produced. Even greater fire resistance and so forth can be provided with additional mineral additive(s). Moreover, the smoke reduction can be provided to a level that is acceptable under existing U.S. and Canadian building codes. Embodiments of the present mineral foam composite can be light weight, which, say, have densities about from 10.0 lb./cu. ft. to, which, say, can provide superior thermal barrier physical properties, say, a Class A rating, when compared to conventional two-component urethane foams common in the prior art, for example, when tested according to the ASTM-E119 or corresponding Can4/ULC-S124 test protocol and/or provide superior results, i.e., a marked decrease, in flame spread and smoke developed ratings when compared to a conventional two-component urethane foam, for example, under the ASTM-E84 or corresponding Can4/ULC-S 102 test protocol. Furthermore, thermal barrier protection without covering decorative features of a synthetic plastic veneer can be provided in decorative products. Thus, a synthetic composite product can provide the advantages and appeal of the decorative product without the need for a separate thermal barrier cover. In addition, lightweight core materials for structural insulated panels (SIPs), light weight materials for pipe insulation cover, and a variety of other applications are provided. What is more, the product can be highly uniform throughout with respect to the mineral additive. For example, a combination of ATH, CSD and Mg(OH)₂ can be blended with the polyol side for a polyurethane foam before being reacted with isocyanate, which provides the desired effects at a low overall cost, and with little if any settling of the mineral additives when thus blended and reacted. Also, as alluded to above, such a combination can be provided in a separate 3rd stream. A reactive diluent, for example, a liquid triaryl phosphate or (tris(2-chloroethyl)) phosphate, can assist in this. Again, one or more of the liquid flame retardant, smoke suppressant, defoamer, dispersant and/or anti-settling agent may be employed. Accordingly, what was formerly a problem in the art, i.e., the limitations of employing foamed plastic and rigid foamed polyurethanes under North American building and fire codes, has been converted into the antithesis of that problem, i.e., a new fire resistant composite material, especially as a rigid polyurethane foam. The invention is highly effective, economical and efficient.

Numerous further advantages attend the invention.

The drawings form part of the specification hereof. With respect to the drawings, which are not necessarily drawn to scale, the following is noted:

Illustration 1 shows a thin skin sandwich panel, which may be considered to be an SIP, wherein “A” is the upper or outer facing material from a suitable structural or fiber-reinforced inorganic board such as “Mag-Board,” say, at a ⅛-to ¼-inch thickness, or other suitable skin material; “B” is the lower or inner facing material from a suitable structural or fiber-reinforced inorganic board such as the Mag-Board, say, at a ⅛-to ¼-inch thickness, or other suitable skin material; and “C” embraces a thermal barrier rated composite of the present invention of adequate thickness to provide the required R-value of application.

Illustration 2 shows decorative interior or exterior cladding or paneling, which may be prepared by a two stage application in rigid, yet flexible decorative mold 1, and which may be a single or dual density rigid composite decorative panel product embracing outer skin 2 that may be made from or with a sprayed-into-place two-component polyurea film, say, applied at about from 15 to 100 microns, for abrasion resistance and weathering durability, and interior core 3 of the of a thermal barrier rated composite of the present invention of adequate thickness to provide a rigid backing material suitable for the required of application. Such decorative paneling otherwise may be made in a single density format in which the durable polyurea outer skin may be eliminated in order to reduce labor and material costs.

Illustration 3 shows 3^{rd} stream injection for a high or low pressure mixing system, which includes an apparatus suitable for incorporating a 3^{rd} stream into an existing two-component polyurethane foam mixing system, in which the apparatus 1′ is representative of a typical two-component polyurethane mix head which may include a integral mechanical mixer in the case of a low pressure system, or an impingement chamber for a self-cleaning, high pressure, reaction injection molding (RIM) system, and is upgraded with a third port to handle the introduction of the 3^{rd} stream poly-blend via a metering system, pressurized when necessary; A-side 2′ is an isocyanate stream delivered to the mix head of the apparatus 1′, say, by gravity feed for a low pressure mechanical mix system to 1400 pounds per square inch (psi) for a high pressure impingement system such as the RIM system; B-side 3′ is a polyol stream delivered to the mix head of the apparatus 1′, say, again, by gravity feed for a low pressure mechanical mix system to 1400 psi for a high pressure impingement system such as the RIM system; and 3^{rd} stream delivery system 4′, which is metered and pressurized where necessary, contacts the 3^{rd} stream blend with the A-side and B-side components 2′, 3′ at the mixing head of the apparatus 1′.

The invention can be further understood by the detail set forth below. As with the foregoing, such is to be taken in an illustrative and not necessarily limiting sense.

At the outset, exemplary of the invention is a filled polyurethane foam. A polyurethane generally refers to the reaction product of a polyfunctional isocyanate with a polyol, which, in general, may result in a polyurethane per se; the reaction products of isocyanates with themselves; or the reaction of a polyfunctional isocyanate with any hydrogen donor to produce a polymerized compound.

Generally, the present composition evolves water at elevated temperatures, say, as would be encountered in combustion of the composite. Such temperatures may be about 120° C. and above, about 140° C. and above, or about and above any other suitable temperature(s). A multi-tiered release of water may occur, for example, with a first release about 140° C., a second release about 240° C., and perhaps a third or more release about 300° C. or 400° C. or above.

A thermal barrier, fire and/or smoke retardant polyurethane composite mineral foam can be made by steps embracing providing and reacting a liquid isocyanate side (A-side), which contains a polyfunctional isocyanate, with a polyol (B-side), in the presence of the mineral fillers and complimentary materials. As mentioned previously, other ingredients may be provided and, as may be appropriate, reacted therewith or remain inert.

With respect to the A-side and its isocyanate, a polyfunctional isocyanate is an isocyanate or mixture of isocyanates having an average functionality greater than one. Polyfunctional isocyanates can include di-, tri- or tetra-isocyanates, or a mono-functional isocyanate employed in a mixture with an isocyanate of higher functionality. Common aromatic polyfunctional isocyanates that may be employed include pure or mixed isomers of toluene diisocyanate (TDI), diphenylmethane diisocyanate (MDI) and polymeric MDI. Common aliphatic or cyclo-aliphatic polyfunctional isocyanates that may be employed include hexamethylene diisocyanate (HDI) and isophorone diisocyanate (IPDI). The polyfunctional isocyanate may be commercially obtained; for example, it may be HAD-M7000-32 (Carpenter Co., Richmond, Va.). Any other suitable alternative or equivalent may be employed.

Separate from the A-side, with respect to the B-side and its polyol, a polyol mixture can be prepared, which can contain the polyol and other ingredients such a blowing agent, for example, water, and a catalyst, for example, potassium 2-ethylhexanoic acid, potassium acetate or (tri(dimethylaminomethyl)) phenol. A polyol generally is a polyhydroxy organic compound, and it may be formed by a polymeric reaction product of an organic oxide and a compound containing two or more active hydrogen moieties. For example, polyether polyols are based on propylene oxide terminated with a secondary hydroxyl group. Typical of polyols that are used in commercial urethane foam production and that may be employed herein include 1,4-butanediol; hydroxy terminated polyethylene oxide, and polypropylene oxide. The polyol can be commercially obtained; for example, it may be EB-HDB-900 polyether polyol (Carpenter Co., Richmond, Va.). Any other suitable alternative or equivalent may be employed. A “reactive diluent” may be provided for the B-side. The reactive diluent acts to reduce the viscosity of the polyol and permit blending of the mineral additive, often with only a small portion of B-side ingredients, say, 1% to 10% by weight, without increasing the viscosity to the extent that handling and mixing would be adversely affected; and may enhance homogeneity of the mixture. For instance, the reactive diluent may be a suitable organic phosphorus compound such as a liquid triaryl phosphate or trialkyl phosphate or mixed trialkyl-triaryl phosphate, to include halogenated version(s) thereof, for example, (tris(2-chloroethyl))phosphate, which is commercially available as Fyrol CEF (Supresta LLC, Ardsley, N.Y.). Any of a number of other suitable, generally low viscosity liquid phosphate or phosphine compounds may be employed.

The mineral additive, say, in particulate form, may be incorporated into the polymeric matrix in any suitable manner. For instance, with respect to a polyurethane based composition, it may be part of the B-side itself, say, as provided by admixing the mineral additive with a polyol and other ingredients to form the B-side mixture with mineral additive. Thus, a polyol blend may be diluted with the reactive diluent, and then particulate mineral additive hydrates, for example, ATH and CSD, or ATH, CSD and Mg(OH)₂, can be blended to form a homogeneous mix to form the B-side. The mineral additive, again, for example, ATH and CSD, or ATH, CSD and Mg(OH)₂, may also be blended in a liquid concentrate to form a storage-stable 3rd stream, which may be introduced into the B-side at the mix head, by using only a small amount of the polyol. Thus, say, about from 1% to 10% of the polyol by weight of the concentrate may be employed, with the remainder of the concentrate the mineral additive, and generally, too, the reactive diluent, and any further blended anti-settling agent(s), defoamer(s) and/or dispersant(s), to make the storage-stable 3rd stream. This 3rd stream may be mixed with the A-side and B-side when preparation of the final product is desired. Perhaps, too, the mineral additive may be part of the A-side, or even added neat immediately after mixing of an A-side with a B-side. In any event, a suitable ratio of the A-side and B-side, or A-side, B-side and 3^{rd} stream mixture can be contacted to produce a polyurethane-based composite mineral foam having suspended therein the particulate mineral additive. This polyfunctional isocyanate and polyol/filler blend can be mixed for a period of time at temperatures sufficient to initiate polymerization to form the polyurethane. The pertinent mixture may be discharged into a mold, covered and left to rise and fill the cavity for form a finished part.

The mineral additive may be provided by a combination of two or more hydrated mineral fillers, which function to increase the thermal barrier properties of the polyurethane composite mineral foam, especially, for example, through enhanced fire resistance and/or smoke retardance. Accordingly, there may be, first and second, even third or more mineral additives.

The first mineral filler can be a basic, hydrated or hydroxylated, particulate mineral filler capable of evolving water, but has a bulk density that is considerably lower than the second mineral additive, especially lower than ATH, and has a lower decomposition temperature, for instance, below 200° C. or thereabout, say, between about 100° C. and 200° C., which may be, for example, CSD, or another suitable compound that releases water vapor when heated below 200° C. Typically, for example, CSD will release most of its water at about 140° C., and it assists in reducing both the smoke developed rating and also contributes to the much improved thermal barrier rating by interrupting the chemistry of combustion during the early stages of the fire and affording marked improvement in delays in temperature rise through the mineral foam core which translates into the improve thermal barrier properties. Amounts of the first mineral additive can vary; for instance, they may be about from 1.5% to 20.5% or about from 14.5% to 20% by weight of a liquid B-side mixture excluding any reactive diluent, other mineral additive or other material. For example, CSD may be added at about 15% by weight of the liquid B-side.

The second mineral additive can be a basic, hydrated or hydroxylated, particulate mineral filler capable of evolving water at a temperature at least 200° C. or thereabout, and somewhat above that, say, about from 200° C. to 300° C., for example, ATH. Typically, for example, ATH will release most of its water at about 240° C. Amounts of the first mineral additive can vary; for instance, they may be about from 1.5% to 19.5% or about from 3.1% to 6.2% or 10% by weight of the liquid B-side mixture including any reactive diluent or second or more mineral additive or other material. For instance, ATH may be added at about 3.5% or 7.5% by weight of B-side.

The third mineral additive can be another water-releasing compound, say, again, a basic, hydrated or hydroxylated, particulate mineral filler capable of evolving water, which may be at any suitable temperature, say, at a temperature somewhat above the first and second mineral fillers, for instance, at a temperature at least about 300° C. or at least about 400° C., especially when such first and second mineral additives as set forth above are present. For example, such a third mineral additive can be Mg(OH)₂, which releases most of its water about from 400° C. to 450° C., which can reduce visible smoke of combustion. Amounts of the third mineral additive can vary. They may be about from 0.1% to 10% by weight of the B-side, to include about from 0.5% to 3%, by weight of B-side. For example, Mg(OH)₂ may be added at about 2% by weight of the B-side.

A fourth mineral filler may be, for example, zinc borate, which also can reduce visible smoke of combustion. It may be added about from 0.1% to 10% by weight of the 3rd stream.

Other mineral additives can include further hydrated and/or hydroxylated mineral filler compositions, which may include di-, tri-, tetra-, penta-, sexta-, septa-, octa- nona- and deca- and even higher hydrates, or other hydroxides. As an illustration, for even greater fire resistance and so forth, a metal hydrate having a high water of crystallization, say, from cupric sulfate pentahydrate (CuSO₄.5H₂O) with five moles of water to a highly hydrated mineral such as Ettringitte (Ca₆.Al₂.(SO₄)₃.26H₂O) with twenty-six moles of water, which would be available for cooling, quenching and ever greater thermal resistance during combustion, may be employed independently or in conjunction with another mineral additive.

The mineral additive may have any suitable particle size, for instance, from about 1, 3, 5 or 10 to some 10, 25, 50, 75 or 100 microns, more or less. For example, ATH can be provided in varying particle sizes about from 5 to 50 microns; CSD can be provided in varying particle sizes about from 5 to 75 or 100 microns; Mg(OH)₂ can be provided in varying particle sizes about from 5 to 100 microns; and zinc borate can be provided in varying particle sizes about from 5 to 100 microns. Thus, the mineral additive may be finely divided sufficiently to produce a slurry when mixed with the polyol and any reactive diluent

Materials for making the polyurethane can be those materials and/or compounds, which, when mixed at the appropriate ratios, produce a rigid polyurethane foam. For instance, such materials can have ingredients similar to or made or sold by Urethane Technologies Corporation of Newburgh, N.Y., under the designation, “UTC-6022-7.5FR,” and, as noted above as with most if not all polyurethane systems, such ingredients are provided in two parts, the A-side and B-side. Generally its B-side contains polyols, blowing agents, and catalytic agents, and has a viscosity of 150˜350 cP and a specific gravity of 1.22˜1.24 at 77° F. (25° C.). Its A-side is a polyisocyanate component containing polymethylene-polyphenyl-isocyanate, and has a viscosity of 1000˜4200 cP and a specific gravity of 1.10 at 77° F. (25° C.). When appropriately mixed, and dispensed, for instance, by casting, spraying, and so forth, these two main ingredients produce a cured polyurethane material having a density of 5˜25 pounds per cubic feet. The mixing ratio of the A-side (UTC-6022-7.5 FRA) to the B-side (UTC-6022-7.5 FRB) can be any suitable ratio, for instance, about 1:1.55 by weight. The two sides can be dispensed, for instance, by hand, by mixing gun, and so forth; and reacted, say, at temperatures of 60˜250° F. (16˜121° C.). Other materials can be employed, and, of course, may vary in weight, viscosity, specific gravity, mixing ratio, and so forth. To such ingredients, say, with the B-side, is added any reactive diluent and the mineral additive, or dispatched separated to the B-side from a B′-side or other 3rd stream, as noted elsewhere herein.

Additional materials may be added. For instance, a chopped aramid fiber and/or a chopped carbon fiber may be added. Each or both may be have independently an about 0.5-mm or an about 1-mm to an about 6-mm or an about 20-mm length. The chopped aramid fiber, for example, may be poly(p-phenylene terephthalamide) and/or poly(m-phenylene isophthalamide). A pigment such as iron oxide, titanium dioxide, and so forth may be employed. The additional material(s) may be provided in any suitable amount. For instance, the chopped aramid and/or carbon fiber(s) may be present about from 0.1% to 10% by weight of total composite; the iron oxide pigment may be present about from 0.01% to 5% by weight of the total composite.

The present composite may embrace any suitable percentages for its components. For instance, considered by weight of reactants, an illustrative cured rigid thermal barrier mineral foam polyurethane-based composite may have about from 30% to 50%, to include about from 35% to 45%, polyol; about from 30% to 50%, to include about from 35% to 45%, isocyanate; about from 5% to 10%, to include about from 6% to 8%, reactive diluent, for example, Fyrol CEF; about from 5% to 15%, to include about from 8% to 12%, CSD; about from 2% to 7%, to include about from 3.5% to 4.5%, ATH; optionally about from 1% to 5% or 10% Mg(OH)₂; optionally about from 1% to 5% zinc borate; and so forth and the like. It as well may embrace colored pigments, chopped fiber and/or other functional and/or complimentary components.

A polyurethane may be substituted by or augmented with an analog thereof and/or another type polymer. For instance, the other type of polymer may be polymethylmethacrylate.

The following examples further illustrate the invention. Therein, parts and percentages are by weight unless otherwise specified.

### EXAMPLE 1

Two storage tanks are provided to hold reagents. In one tank is an isocyanate—in this case, HAD-M700-32. In the other tank is a mixture of polyol, in this case EB-HDB-900; reactive diluent, in this case Fyrol CEF; and the ATH and CSD mineral filler fire retardant blended together in a premix. In addition, a small quantity of an iron oxide pigment was added to help differentiate this product from other—typically yellow colored—urethane products of this type. When the contents of the two storage tanks are properly blended together at appropriate ratios, as outlined herein below, a reaction occurs and a polyurethane-based thermal barrier mineral foam, fire retardant, fire resistant and/or smoke retardant composite is produced.

Two liquid parts referenced as Part A and Part B were formulated as follows:

| | | | |
|---|---|---|---|
| Part A: | Isocyanate | 770 lb. | 41.10% |
| Part B: | Polyol | 756 lb. | 40.25% |
| | Reactive diluent | 108 lb. | 05.75% |
| | Brown oxide pigment | 22.5 lb. | 01.20% |
| | CSD | 162 lb. | 08.60% |
| | ATH | 60.0 lb. | 03.20%. |

When these two liquids were blended at room temperature, say, between 60° F. and 75° F., using a high shear mixer, at a ratio of 1.3 parts of A to 2.0 parts of B (wt./wt.) and cast in a six sided rectangular mold, the result was a rigid composite mineral foam slab with a density about from 12 to 18 lb./cu. ft., depending on the quantity of the mixed materials to the size of the mold and the pressure or constraints exerted on the mold during the iso/polyol foaming reaction.

When a sample of 2.32 lbs. of the above mentioned blend of materials was cast in a 12″×24″×1″ mold, the result was a solid mineral foam composite having a density of 14 lb./cu. The lid of the mold was constrained in a press at 20 psi to prevent the rising foam from escaping the gap (by lifting the lid) between the mold and the lid.

When cast as one-inch thick panels by 12 inches×24 inches and placed edge to edge over a 24-foot Steiner Tunnel and tested under Can4/ULC-S 102, the 10-minute Steiner Tunnel Test, the results after three such tests consistently demonstrated an average flame spread of 15 and a smoke developed rating of less than 350. The combination of these performance characteristics based on these approved test methods makes the composite suitable for use as a Thermal barrier mineral foam composite, and it may be used on interior surfaces in most occupancies under the North American Model Building Codes, without having to be covered with drywall or the like.

The composite, when cast in a rigid shape at 3 ft×3 ft×1.5 inches was subject to testing under the Can4/ULC-S 124 15-minute thermal barrier test. The composite offered a Class A 15-minute thermal barrier rating at its nominal thickness of 1.5 inches.

### EXAMPLE 2

Three storage tanks were provided to hold three streams of reagents. In one tank was isocyanate, HAD-M700-32. In the second tank was polyol, EB-HDB-900. In the third tank was a mixture of EB-HDB-900; reactive diluent, in this case Fyrol CEF; the ATH and CSD mineral additives; along with additional liquids and solids to improve flow, anti-settling, defoaming stability, and an iron oxide pigment all blended together in a premix.

When the contents of the three tanks were properly blended together at appropriate ratios, as outlined herein below, a reaction occurs and a polyurethane-based thermal barrier mineral foam, fire and/or smoke retardant composite is produced.

Three liquid parts referenced as Part A, Part B and Part B′ were blended as follows:

| | | |
|---|---|---|
| Part A: | Isocyanate of (HAD-M700-32 from Carpenter) | 41.11% |
| Part B: | Polyol (EB-HDB-900 from Carpenter) | 35.08% |
| Part B′: | 3^{rd} Stream blend | 24.81%. |

Part B′, the 3^{rd} stream blend, included the following, with percentages referring to Part B′ itself:

| | | |
|---|---|---|
| (1) | The polyol of Part B | 21.8% |
| (2) | Reactive diluent (Fyrol CEF tris(2- | 25.92% |
| | chloroethyl)phosphate) | |
| (3) | Flexibilizer (dibutyl phthalate) | 06.49% |
| (4) | ATH (micronized version, less than 10 microns) | 12.49% |
| (5) | CSD (size 15 to 50 microns) | 31.06% |
| (6) | Brown oxide pigment from Hilton Davis | 01.55% |
| (7) | El-100 anti-settling agent from Addison Chemical | 00.05% |
| (8) | Byk 410 (solution of modified urea, anti-settling | |
| | agent from Byk-Chemie) | 00.11% |
| (9) | Byk 054 (solution of foam-destroying polymers | |
| | from Byk-Chemie) | 00.08%. |

When these three liquid streams were blended at room temperature, say, between 70° F. and 80° F., using a high shear mixer, at a ratio of 411 parts of A to 351 parts of B and 240 parts of B′ (wt./wt.) and cast in a six sided rectangular mold, the result was a rigid Thermal barrier Composite mineral foam slab with a density about from 12 to 15 lb./cu. ft., depending on the quantity of the mixed materials to the size of the mold and the pressure or constraints exerted on the mold during the iso/polyol foaming reaction. The resulting mineral foam composite offered performance characteristics equivalent to those found in Example 1 above.

### EPILOGUE

In actual full scale tests, a commercially available Class 1 fire retardant polyurethane foam was cast as decorative stone panels and tested under the CAN/ULC-S 102-03 Steiner Tunnel test. Two sets of tests were run. Both were identical in appearance. One was based on the unaltered, 2-component iso/poly blend, a Class A high density foam from Carpenter Industries, while the second was based on the same Carpenter products, but upgraded to include about 25% by weight of the synthetic 3rd stream polymer blend including the mineral additives of the present invention.

### EXAMPLE A

Unaltered “fire retardant” polyurethane foam from Carpenter marketed under the trade name ProTech HDB900-1 for the polyol resin in combination with an isocyanate labeled HAD-M700-32

| | | |
|---|---|---|
| Part by weight of polyol resin: | 1.1 | |
| Part by weight of isocyanate: | 0.9 | |
| Free rise density: | 9.0 lb./cu. ft. | |
| In-place final density: | 12-14 lb./cu. ft. | |
| Average results after two tests: | Flame spread rating: | 150 |
| | Smoke developed rating: | 600+. |

### EXAMPLE B

Upgraded thermal barrier mineral foam composite based on that Carpenter product but modified as outlined herein:

| | | |
|---|---|---|
| Part by weight of polyol resin: | 0.9 | |
| Part by weight of isocynate: | 0.9 | |
| Parts by weight of 3^{rd} stream: | 0.4 | |
| In-place final density: | 14 to 16 lb./cu. ft. | |
| Results after three tests (average): | Flame spread rating: | 15 |
| | Smoke developed rating: | 350. |

The results were telling. The unaltered “fire retardant” polyurethane foam resulted in a flame spread of 150 and a smoke developed rating of 600 or higher. In contrast, when the upgraded blend, which included 25% by weight of a thermal barrier upgrade ingredient of the present invention, was cast in panels of the same dimension and thickness as those used in the first test, the flame spread rating was reduced from 150 to 15, and the smoke developed rating was reduced from 600 or higher to 350.

In addition, when these two different blends were cast into 1.25-inch thick sheets and subjected to the Can/ULC-S 124 thermal barrier test, the unaltered foam was burned completely away within 4 minutes and failed. The sample modified by being upgraded with the 25% by weight of the synthetic polymer blend slurry including a mineral additive survived for a full 15 minutes and exceeded the thermal barrier resistance with time and temperature to spare.

In connection to the thermal barrier upgrade, too, in actual full scale tests, the commercially available Carpenter Class 1 fire retardant polyurethane foam product/system was cast as decorative stone panels at 3 feet by 3 feet by 1.25 inches thick, and tested in accordance with Can/ULC S-124. Two sets were made and tested. Both were substantially identical in appearance. One was the two-component iso/poly blend unaltered, a Class A foam from Carpenter Industries, while the second was based on the same Carpenter products, but upgraded to include the about 25% by weight of present synthetic polymer blend including mineral additive. The results again were telling. The unaltered “fire retardant” polyurethane foam burned through and fell to the bottom of the test chamber in just 4 minutes, failing to provide even a Class C or 5-minute thermal barrier rating. In contrast, when the present upgraded blend was cast in panels of the same dimension and thickness as those used in the first test, the panels stayed in place for a full 20 minutes—at which point the test was concluded. The test results indicated that at 1.25 inches of thickness, the present composite material offered a Class A, 15-minute thermal barrier rating.

Persons skilled in the art are provided numerous advantageous embodiments hereby, among which can be found those such as follows:

1. A light weight mineral foam composite with sufficient fire resistance to withstand at least 15 minutes exposure to a temperature of or in excess of 1200° F. in order to qualify as a Class A thermal barrier mineral foam composite when tested to the building code approved test Can/ULC-S124 or the ASTM-E119 for 15 minutes at or about from 1.0 inch to 1.5 inches of thickness.

2. A light weight mineral foam composite with sufficient fire resistance to withstand the rigors of a “corner test” when subjected to the UL 1715 “Standard for Safety Fire Test of Interior Finish Materials” at or about from 1.0 inch to 1.5 inches of thickness.

3. The composite as found in embodiment 1 or 2 above, which has adequate flame resistance to offer a Class 1 flame spread rating of less than 25 when tested to Can/ULC-S 102 or the ASTM-E84 Steiner Tunnel test at or about from 1 inch to 1.5 inch of thickness.

4. The composite as found in embodiment 1 or 2 above, which has adequate smoke suppressant capability to offer a smoke developed rating of 450 or less when tested to Can/ULC-S102 or the ASTM-E84 Steiner Tunnel Test.

5. A process of manufacturing a polyurethane foam-based composite admixture, which can embrace: (a) blending as a liquid mixture a polyol with agents, among which are fire retardant/fire resistant agents, that can include about from 1% to 10% by weight reactive diluent, which may be tris(2-chloroethyl)phosphate; about from 0.1% to 4.5% by weight liquid flexibilizer, which may be a fully reactive, solvent-free agent such as dibutyl phthalate; about from 1.5% to 5.5% by weight finely divided ATH, which may be on the order of 5 to 50 microns in size; about from 5% to 10% by weight finely divided CSD, which may be on the order of 5 to 100 microns in size; and 0%, from 0% to about 1.5%, or about from 0.5% to 1.5% by weight fine powdered pigment, which, if present, say, may be a fine powdered iron oxide; (b) feeding the mixture from step (a) to a mixer to which is introduced a liquid isocyanate; then (c) mixing these components together with reactive polymerizing or curing of the mixed components occurring then and/or thereafter to form a lightweight, rigid, thermal barrier mineral foam composite having a density about from 5 to 25 lb./cu. ft.

6. The process as found in embodiment 5, wherein the polymerization reaction is conducted in a high intensity mechanical mixer or in a RIM device.

7. A composition made from the process of embodiment 5 or 6.

8. An apparatus for production of a polyurethane-based mineral foam composite in accordance with the process as found in embodiment 5 or 6, which embraces a vessel to hold a blend of polyol resin including fire retardant, smoke suppressant and fire resistant fillers which function to provide the low flame spread, low smoke ratings and thermal barrier properties; an introduction means for bringing a polyol component including a polyol with the polyol-fire retardant blend that may be found in embodiment 5 and 6 together; and then providing a means of contacting this filled stream with the polyol component, which may be clear; a means for mixing the isocyanate component with the polyol component; and an introduction means for introducing a polymer resin component and, the polyol component; and a high speed mixing means for further mixing of the isocyanate component with the polyol component enabling homogeneous polymerization—which apparatus may further include a means to recirculate the isocyanate stream, clear polyol stream, and the filled fire retardant stream through three closed circuits between production cycles or until called for by an automated mixer when each is discharged in a predetermined quantity, weight or volume to the mixing means in sufficient ratios to produce a homogeneous consistency and deposited in a mold or other device suitable to the end-purpose of the rigid part.

9. The apparatus as found in embodiment 8, wherein the holding vessel and metering system are provided with a pressurized atmosphere.

10. The apparatus as found in embodiment 8 or 9, wherein the means for mixing the polyol component with the filled 3^{rd} stream and the isocyanate component is a mechanical mixer and/or a RIM device.

11. A blend of polyol, reactive diluent, mineral additives and flexibilizer, especially for a B′-side or 3^{rd} stream for mixture and reaction with an A-side and B-side for making a polyurethane type polymer, which also includes several additives in small quantities that assist in ensuring that the filled 3^{rd} stream can be a storage stable dispersion, which may include more particularly wherein the storage stability of the 3^{rd} stream can be enhanced by the addition of about from 0.05% to 0.15% by weight of an anti-settling agent such as Byk 410; about from 0.03% to 0.07% by weight of an anti-settling agent such as EI-100; about from 0.03% to 0.09% by weight of a defoaming agent such as Byk 054; and/or about from 005% to 0.05% by weight of a very finely divided fumed silica such as Aerosil 380 from Degussa.

12. The blend such as can be found in embodiment 11, wherein proportions by weight of its component are as follows: polyol about from 10% to 25%; reactive diluent about from 10% to 30%; flexibilizer about from 3.5% to 7.5%; ATH about from 10% to 20%; CSD about from 20% to 35%; metal oxide pigments about from 0% to 3%; Byk-410 about from 0.05% to 0.20%; EI-100 about from 0.05% to 0.10%; and Byk-054 about from 0.05 to 0.15%.

13. A thermal barrier, fire resistant polyurethane-based mineral foam composite as disclosed above and based on the reaction between polyol with an isocyanate and a 3^{rd} stream dispersion of highly effective, fire retardant and fire resistant additives, which is further enhanced by the addition of 1% to 5% or 10% finely divided powdered Mg(OH)₂ to enhance the long term fire resistance and also to further reduce the visible smoke resulting from sustained exposure to elevated temperatures sufficient to otherwise sustain combustion.

14. An article of manufacture, embracing an article manufactured from a fire resistant polyurethane-based thermal barrier rated mineral foam composite.

15. The article of embodiment 14, which has more than one density or layer, which can include an exterior hard coat of a more weather-resistant material such as a polyurea applied to an exterior face of the article, and which can be carried out as a further step in the production cycle, or which can be carried out by applying the polyurea to an interior face of a mold prior to being filled with the liquid material that is mixed and reacts to form the composite.

16. The article of embodiment 14, wherein the final product includes a sandwich panel construction or SIP filled with the composite material, and covered on both sides with structural skins or panels that do not necessarily of themselves, meet the requirements of a 10- to 15-minute Thermal barrier rating under a North American building code, but are acceptable nonetheless by virtue of the improved thermal resistance and fire rating of the composite core.

17. A rigid plastic foam composite comprising the fire retardant agents and fire resistant fillers as found in any one of the foregoing embodiments, notably embodiments 1-4 et seq., which has a density about from 7 lb/cu. ft. to 25 lb./cu. ft.

### CONCLUSION

The present invention is thus provided. Various feature(s), part(s), step(s), subcombination(s) and/or combination(s) may be employed with or without reference to other feature(s), part(s), step(s), subcombination(s) and/or combination(s) in the practice of the invention, and numerous adaptations and modifications can be effected within its spirit, the literal claim scope of which is particularly pointed out as follows:

What is claimed is:

1. A thermal barrier synthetic polymer composite, which comprises a synthetic polymer matrix made from reaction of a mixture of at least an isocyanate and an active hydrogen containing compound, in intimate admixture and combination with at least one water-releasing mineral additive such that thermal barrier, fire resistance, fire retardant and smoke reducing properties are provided by the composite.

2. The composite of claim 1, wherein the isocyanate includes a polyisocyanate; the active hydrogen containing compound includes a polyol; and the at least one water-releasing mineral additive includes two or more mineral additives selected from the group consisting of a metal hydrate, a metal hydroxide, and a combination thereof.

3. The composite of claim 2, wherein the mixture further comprises a reactive diluent.

4. The composite of claim 1, which can release water from the at least one water-releasing mineral additive at a temperature between about 100° C. and 200° C. plus a temperature least about 200° C.

5. The composite of claim 4, which can further release water from the at least one water-releasing mineral additive at a temperature at least about 300° C.

6. The composite of claim 2, which can release water from the at least one water-releasing mineral additive at a temperature between about 100° C. and 200° C. plus a temperature least about 200° C.

7. The composite of claim 6, which can further release water from the at least one water-releasing mineral additive at a temperature at least about 300° C.

8. The composite of claim 1, wherein the at least one water-releasing mineral additive includes CSD and ATH.

9. The composite of claim 1, wherein the at least one water-releasing mineral additive includes CSD, ATH and Mg(OH)₂.

10. The composite of claim 2, wherein the at least one water-releasing mineral additive includes CSD and ATH.

11. The composite of claim 2, wherein the at least one water-releasing mineral additive includes CSD, ATH and Mg(OH)₂.

12. The composite of claim 1, which embraces a generally light weight mineral foam, which has sufficient fire resistance to withstand at least 15 minutes exposure to at least 1200° F. in order to qualify as a Class A thermal barrier mineral foam composite when tested to Can/ULC-S124 or ASTM-E119 for 15 minutes at from 1.0 inch to 1.5 inches of thickness of the composite.

13. The composite of claim 12, which has sufficient fire resistance to withstand a corner test when subjected to the UL 1715 standard for safety fire test of interior finish materials at from 1.0 inch to 1.5 inches of thickness of the composite.

14. The composite of claim 12, which has a Class 1 flame spread rating of less than 25 when tested to Can/ULC-S 102 or the ASTM-E84 Steiner Tunnel Test at from 1 inch to 1.5 inch of thickness of the composite.

15. The composite of claim 12, which has a smoke developed rating of 450 or less when tested to Can/ULC-S 102 or the ASTM-E84 Steiner Tunnel Test.

16. The composite of claim 12, which is in a form of a building structure component.

17. The composite of claim 16, which has more than one density or layer, which includes an exterior hard coat of a more weather-resistant material applied to an exterior face of the article.

18. The composite of claim 16, which includes a sandwich panel construction filled with the composite material, and covered on both sides with structural skins or panels that do not necessarily of themselves, meet the requirements of a 10 to 15-minute thermal barrier rating under a model North American building code, but are acceptable by virtue of the improved thermal resistance and fire rating of the composite core.

19. The composite of claim 16, which has a density about from 10 to 25 lb./cu. ft.

20. A process of manufacturing a polyurethane foam-based composite, which comprises the following steps:
(A) blending as a liquid mixture, a polyol with agents, among which are fire retardant/fire resistant agent(s), which include about from 1% to 10% by weight reactive diluent, at least some of which is tris(2-chloroethyl)phosphate; about from 0.1% to 4.5% by weight liquid flexibilizer, at least some of which is dibutyl phthalate; about from 1.5% to 5.5% by weight finely divided ATH, at least some of which is about from 5 to 50 microns in size; about from 5% to 10% by weight finely divided CSD, at least some of which is about from 5 to 100 microns in size; and from 0% to about 1.5% by weight fine powdered pigment, at least some of which, if present, is a fine powdered iron oxide;
(B) feeding the mixture from step A to a mixer, to which is introduced a liquid isocyanate; and
(C) mixing these components together with reactive polymerizing or curing of the mixed components occurring then and/or thereafter to form a lightweight, rigid, thermal barrier mineral foam composite having a density about from 5 to 25 lb./cu. ft.

21. An apparatus useful for production of a polyurethane-based mineral foam composite in accordance with a process that embraces (A) blending as a liquid mixture, a polyol with agents, among which are fire retardant/fire resistant agent(s), which include about from 1% to 10% by weight reactive diluent, at least some of which is tris(2-chloroethyl)phosphate; about from 0.1% to 4.5% by weight liquid flexibilizer, at least some of which is dibutyl phthalate; about from 1.5% to 5.5% by weight finely divided ATH, at least some of which is about from 5 to 50 microns in size; about from 5% to 10% by weight finely divided CSD, at least some of which is about from 5 to 100 microns in size; and from 0% to about 1.5% by weight fine powdered pigment, at least some of which, if present, is a fine powdered iron oxide; (B) feeding the mixture from step A to a mixer, to which is introduced a liquid isocyanate; and (C) mixing these components together with reactive polymerizing or curing of the mixed components occurring then and/or thereafter to form a lightweight, rigid, thermal barrier mineral foam composite having a density about from 5 to 25 lb./cu. ft., which apparatus comprises a vessel to hold a blend of a polyol resin including fire retardant, smoke suppressant and fire resistant fillers; an introduction means for bringing a polyol component including a polyol with the polyol-fire retardant blend together; a means of contacting this filled stream with clear polyol component; a means for mixing the isocyanate component with the polyol component; and an introduction means for introducing a polymer resin component, and the polyol component; and a high speed mixing means for further mixing of the isocyanate component with the polyol component enabling homogeneous polymerization—which apparatus further includes a means to recirculate the isocyanate stream, clear polyol stream, and the filled polyol with fire retardant stream through three closed circuits between production cycles or until called for by an automated mixer when each is discharged in a predetermined quantity, weight or volume to the mixing means in sufficient ratios to produce a homogeneous consistency and deposited in a mold or other device suitable to the end-purpose of the rigid part.
